(19) United States
(12) Patent Application Publication
(10) Pub. No.: US 2017/0001496 A1
(43) Pub. Date: Jan. 5, 2017

(54) AUTOMOBILE SUNROOF HAVING SMART ELECTRONIC SCREEN

(71) Applicant: COREMATE TECHNICAL CO., LTD., Taoyuan County (TW)

(72) Inventor: Robert Wang, TAOYUAN COUNTY (TW)

(21) Appl. No.: 14/790,695

(22) Filed: Jul. 2, 2015

(51) Int. Cl. B60J 3/04; G02F 1/1333; G02F 1/133

(52) U.S. Cl. CPC B60J 3/04; G02F 1/13318; G02F 1/13338; G02F 1/13306

(57) ABSTRACT

An automobile sunroof having a smart electronic screen includes a sunroof main body. The sunroof main body is disposed in the roof of a car. The sunroof main body includes a glass panel. The glass panel is provided with a liquid crystal film. The liquid crystal film is connected with a power source and a controller. The controller is further connected with an input unit. By the first input unit to transmit a signal to the controller, the liquid crystal film is controlled by the controller to adjust the light transmittance of the liquid crystal film, providing a shading effect.

### BACKGROUND OF THE INVENTION

1. Field of the Invention

The present invention relates to an automobile sunroof, and more particularly to an automobile sunroof able to block the sunlight.

2. Description of the Prior Art

A conventional sunroof includes a glass panel. In general, the glass panel is transparent, allowing the sunlight to enter the passenger compartment. When the user wants to block the sunlight, the glass panel is provided with a shelter, such as a screen, a shading panel or sheathing paper.

Although the shelter of the sunroof has the effect to block the sunlight, it is inconvenient for use. The light transmittance of the glass panel of the sunroof is fixed, and it cannot be adjusted according to the demand of the user or the weather. Accordingly, the inventor of the present invention has devoted himself based on his many years of practical experiences to solve these problems.

### SUMMARY OF THE INVENTION

The primary object of the present invention is to provide an automobile sunroof having a smart electronic screen. The light transmittance of a liquid crystal film can be adjusted as desired, providing a shading effect to enhance the comfort of riding.

In order to achieve the object, the automobile sunroof having a smart electronic screen of the present invention comprises a sunroof main body, a liquid crystal film, a controller, a first input unit, and a power source. The sunroof main body is disposed in the roof of a car. The sunroof main body includes a first glass panel. The liquid crystal film is disposed underneath the first glass panel. The controller is connected with the liquid crystal film. The first input unit is connected with the controller. The power source is externally connected on the liquid crystal film and connected with the controller. The power source supplies electric current to the liquid crystal film.

By the first input unit to transmit a signal to the controller, the liquid crystal film is controlled by the controller to adjust the light transmittance of the liquid crystal film. When the user wants to adjust the degree previous to light for the sunroof main body, he/she can make an adjustment as desired to change the light transmittance of the liquid crystal film, providing a shading effect to enhance the comfort of riding.

### BRIEF DESCRIPTION OF THE DRAWINGS

FIG. 1 is an exploded view according to a first embodiment of the present invention;

FIG. 2 is a block diagram according to the first embodiment of the present invention;

FIG. 3 is a schematic view of a first state of the first embodiment of the present invention;

FIG. 4 is a schematic view of a second state of the first embodiment of the present invention; and

FIG. 5 is an exploded view according to a second embodiment of the present invention.

### DETAILED DESCRIPTION OF THE PREFERRED EMBODIMENTS

Embodiments of the present invention will now be described, by way of example only, with reference to the accompanying drawings.

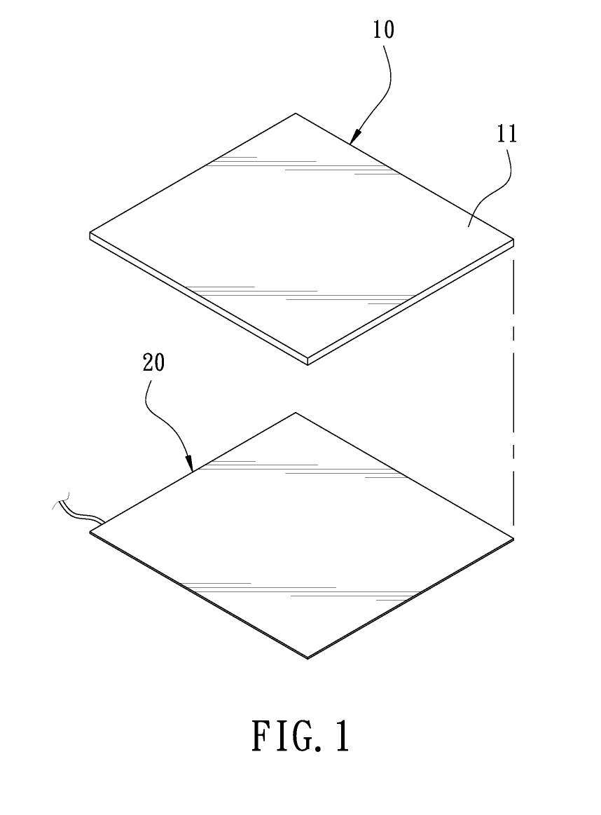

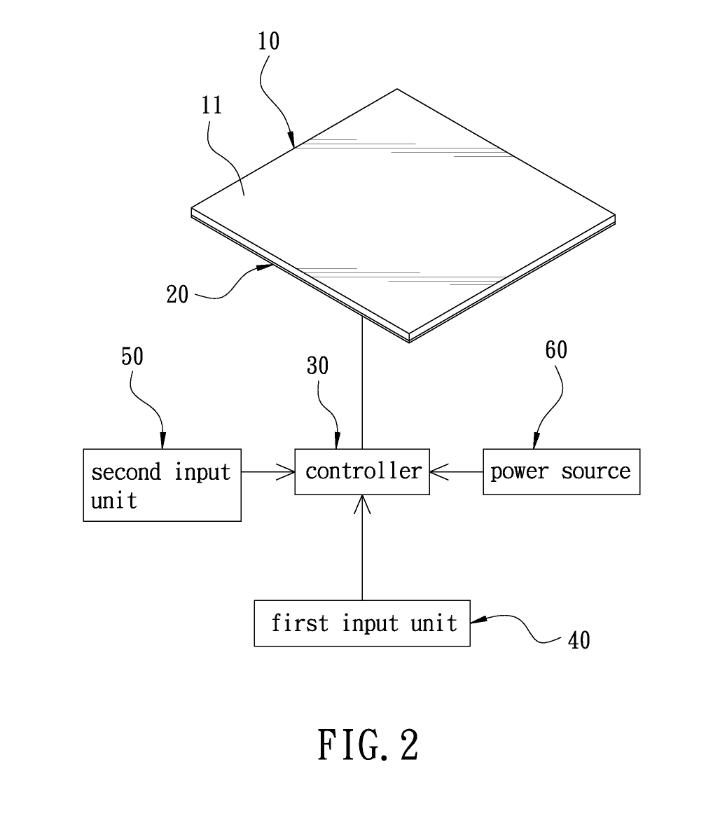

FIG. 1 is an exploded view according to a first embodiment of the present invention. FIG. 2 is a block diagram according to the first embodiment of the present invention. The present invention discloses an automobile sunroof having a smart electronic screen. The automobile sunroof having a smart electronic screen comprises a sunroof main body 10, a liquid crystal film 20, a controller 30, a first input unit 40, a second input unit 50, and a power source 60.

The sunroof main body 10 is disposed in the roof of a car. The sunroof main body 10 includes a first glass panel 11. In this embodiment, the first glass panel 11 is a transparent glass. The color of the transparent glass can be changed.

The liquid crystal film 20 is disposed underneath the first glass panel 11 in a coating or attached manner. The light transmittance of the liquid crystal film 20 is 30%. The liquid crystal film 20 is transparent when not electrified, and it is opaque when electrified.

The controller 30 is connected with the liquid crystal film 20.

The first input unit 40 is connected with the controller 30. The first input unit 40 is a touch panel or a micro adjustment switch.

The second input unit 50 is connected with the controller 30. The second input unit 50 is a sensor. The sensor is a photoresistor.

The power source 60 is externally connected on the liquid crystal film 20, and connected with the controller 30. The power source 60 supplies electric current to the liquid crystal film 20. The power source 60 can be common mains power, solar power, or battery power. The way for the power source 60 to supply power can be wireless or wired.

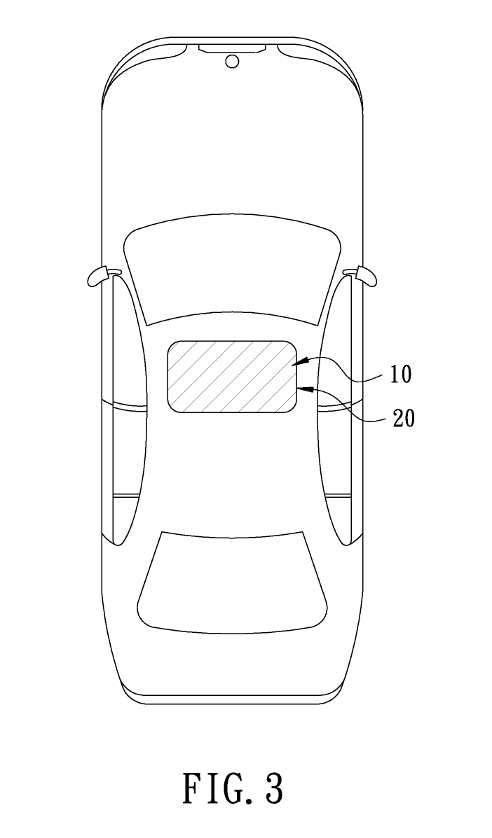

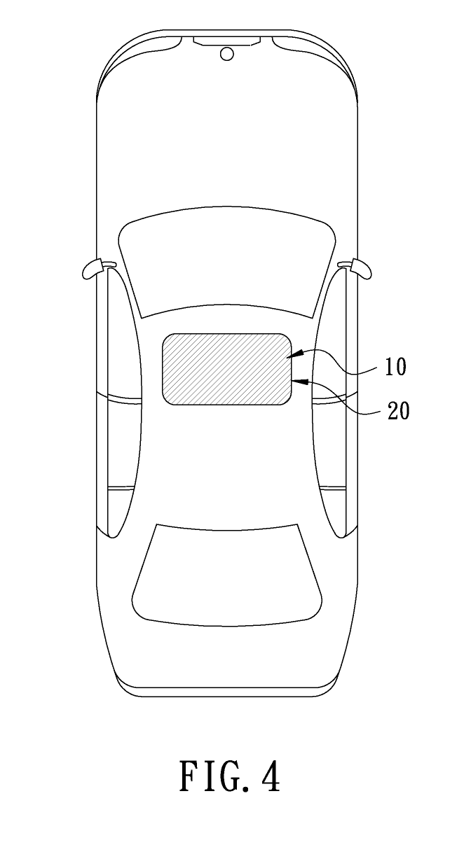

FIG. 3 is a schematic view of a first state of the first embodiment of the present invention. FIG. 4 is a schematic view of a second state of the first embodiment of the present invention. Referring to FIG. 1 and FIG. 2, when the user wants to adjust the degree previous to light for the sunroof main body 10, he/she can start the first input unit 40 to transmit a signal to the controller 30. After the controller 30 receives the signal, the controller 30 is adapted to control the state of the electric current from the power source 60 to the liquid crystal film 20. As shown in FIG. 3, the liquid crystal film 20 is transparent when not electrified. The sunroof main body 10 has the same color as the liquid crystal film 20. The light transmittance of the sunroof main body 10 is 30%. As shown in FIG. 4, the light transmittance of the liquid crystal film 20 is lowered when electrified. That is to say, the color of the sunroof main body 10 becomes darker. In addition, the first input unit 40 also can adjust the light transmittance of the liquid crystal film 20. The user can make an adjustment as desired to change the light transmittance of the liquid crystal film 20, providing a shading effect to enhance the comfort of riding.

In addition to the first input unit 40 to adjust the light transmittance of the liquid crystal film 20 for the automobile sunroof having a smart electronic screen, the user can start the second input unit 50. When the photoresistor senses the sunlight, it will send a signal to the controller 30. The controller 30 further controls the power source 60. When the sunlight is blazing, the light transmittance of the liquid crystal film 20 will be decreased. When the sunlight is weak, the light transmittance of the liquid crystal film 20 will be increased. Accordingly, the light transmittance of the liquid crystal film 20 can be changed according to the sunlight.

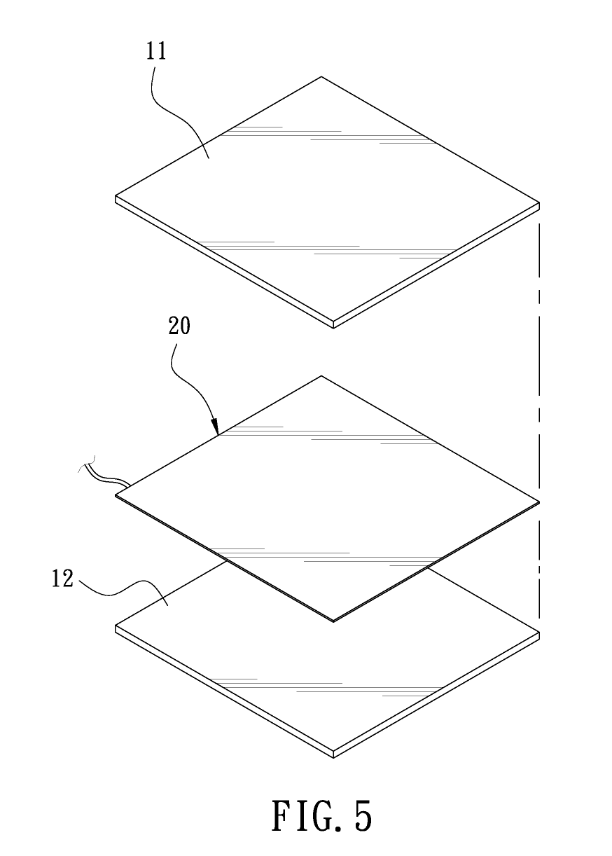

FIG. 5 is an exploded view according to a second embodiment of the present invention. The second embodiment is substantially similar to the first embodiment with the exceptions described hereinafter. The automobile sunroof having a smart electronic screen further comprises a second glass panel 12. The second glass panel 12 is disposed under the first glass panel 11. The liquid crystal film 20 is disposed between the first glass panel 11 and the second glass panel 12. The first glass panel 11 and the second glass panel 12 are attached to the liquid crystal film 20 each other so as to protect the liquid crystal film 20, preventing the liquid crystal film 20 from being scraped or damaged.

It is noted that the liquid crystal film 20 of the automobile sunroof having a smart electronic screen is attached to the glass panel. If the glass panel is broken by impact, the cullet will be stuck to the liquid crystal film 20 to form a net pattern and won't be exploded to hurt the user. The present invention provides an explosion-proof effect.

It is noted that the increase of the light transmittance of the liquid crystal film 20 is able to block the sunlight and to lower the temperature in the car.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An automobile sunroof having a smart electronic screen, comprising:
a sunroof main body, the sunroof main body being disposed in the roof of a car, the sunroof main body including a first glass panel;
a liquid crystal film disposed underneath the first glass panel;
a controller connected with the liquid crystal film;
a first input unit connected with the controller;
a power source, the power source being externally connected on the liquid crystal film and connected with the controller, the power source supplying electric current to the liquid crystal film;
thereby, by input of the first input unit, the liquid crystal film being controlled by the controller to adjust a light transmittance of the liquid crystal film.

2. The automobile sunroof having a smart electronic screen as claimed in claim 1, wherein a second glass panel is provided under the first glass panel, and the liquid crystal film is disposed between the first glass panel and the second glass panel.

3. The automobile sunroof having a smart electronic screen as claimed in claim 1, further comprising a second input unit, the second input unit being connected with the controller, the second input unit being a sensor.

4. The automobile sunroof having a smart electronic screen as claimed in claim 3, wherein the sensor is a photoresistor.

5. The automobile sunroof having a smart electronic screen as claimed in claim 1, wherein the first input unit is a touch panel.

6. The automobile sunroof having a smart electronic screen as claimed in claim 1, wherein the first input unit is a micro adjustment switch.
